(19) United States
(12) Patent Application Publication
(10) Pub. No.: US 2015/0039814 A1
(43) Pub. Date: Feb. 5, 2015

(54) STORAGE DEVICE AND STORAGE SYSTEM INCLUDING THE SAME

(71) Applicant: Samsung Electronics Co., Ltd., Suwon-si (KR)

(72) Inventors: Sun-Young LIM, Hwaseong-si (KR); Jin-Hwa LEE, Seongnam-si (KR); Dong-Hwi KIM, Yongin-si (KR)

(21) Appl. No.: 14/449,343

(22) Filed: Aug. 1, 2014

(30) Foreign Application Priority Data
Aug. 1, 2013 (KR) 10-2013-0091572

(51) Int. Cl. G06F 12/02

(52) U.S. Cl. CPC G06F 12/0246; G06F 2212/7201
USPC 711/103

(57) ABSTRACT

A storage device may include a nonvolatile storage and a storage controller. The nonvolatile storage may include a map table which stores information including a logical address, a physical address corresponding to the logical address and a correlation index designating the physical address. The storage controller is configured to transmit the information to an external host device, and to access the nonvolatile storage based on a request and the correlation index, each of the request and the correlation index transmitted from the host device.

### CROSS-REFERENCE TO RELATED APPLICATION

This application claims priority under 35 USC §119 to Korean Patent Application No. 10-2013-0091572, filed on Aug. 1, 2013, in the Korean Intellectual Property Office (KIPO), the content of which is herein incorporated by reference in its entirety.

### BACKGROUND

1. Technical Field

Example embodiments relate generally to storages, and more particularly to a storage device and a storage system including the same.

2. Description of the Related Art

Recently, many data processing systems include a storage device including a dynamic random access memory (DRAM) as a main memory and a non-volatile flash memory capable of storing data in low power. However, when DRAMs are added to a storage device including flash memory devices, cost and standby current may increase.

### SUMMARY

Some example embodiments provide a storage device, capable of increasing operating speed.

Some example embodiments provide a memory system that includes the storage device.

According to some example embodiments, a storage device includes a nonvolatile storage and a storage controller. The nonvolatile storage includes a map table which stores information including a logical address, a physical address corresponding to the logical address and a correlation index designating the physical address. The storage controller is configured to transmit the information to an external host device, and to access the nonvolatile storage based on a request and the correlation index transmitted from the host device.

In an embodiment, the storage controller is configured to directly access a physical page of the nonvolatile storage in response to the physical address indicating as the correlation index transmitted from the host device.

In an embodiment, when the request is a write request, the correlation index transmitted from the host device may correspond to a correlation index designating a free page of the nonvolatile storage.

In an embodiment, when the request is a read request, the correlation index transmitted from the host device may correspond to a correlation index designating a data page of the nonvolatile storage.

In an embodiment, the storage controller includes a register unit. The register unit includes a command queue configured to store a command corresponding to the request, and an update table configured to store the correlation index. The update table may further store a valid tag that represent whether a physical address corresponding to the correlation index is updated and whether the physical address is valid.

According to some example embodiments, a storage system includes a storage device and a host device. The storage device includes a nonvolatile storage that has a map table which stores information including a logical address, a physical address corresponding to the logical address and a correlation index designating the physical address. The host device includes a main memory configured to store the information of the map table of the nonvolatile storage, the host device configured to transmit the logical address and the correlation index with a request to the storage device. The host device is configured to access the nonvolatile storage based on the request, the logical address and the correlation index.

In an embodiment, the storage device further includes a storage controller configured to directly access a physical page of the nonvolatile storage in response to the physical address indicating as the correlation index transmitted from the host device.

The storage controller may include a processor, a register unit, a host interface and a memory interface. The processor may be configured to control overall operation of the storage device. The register unit may be configured to store a command corresponding to the request, the logical address and the correlation index. The host interface may be electrically coupled to the host device. The memory interface may be electrically coupled to the nonvolatile storage.

The processor may be configured to transmit a message to the host device after the processor loads the information of the map table to the register unit, and the host device may be configured to store the information in the main memory in response to the message.

The register unit may include a command queue and a update table. The command queue may be configured to store a command corresponding to the request. The update table may be configured to store the correlation index. The update table may be further configured to store a valid tag that represent whether a physical address corresponding to the correlation index is updated and whether the physical address is valid. The storage controller may be configured to refer to the update table, and directly access data associated with the physical address corresponding to the correlation index transmitted from the host device.

In an embodiment, when the request is a write request, the correlation index transmitted from the host device may correspond to a correlation index designating a free page of the nonvolatile storage.

In an embodiment, when the request is a read request, the correlation index transmitted from the host device may correspond to a correlation index designating a data page of the nonvolatile storage.

In an embodiment, the host device further includes a central processing unit configured to control overall operation of the host device and the central processing unit may be coupled to the main memory and the storage device each coupled through individual interface.

In an embodiment, the host device may further include central processing unit which controls overall operation of the host device and the central processing unit may be coupled to the main memory and the storage device each coupled through a common interface.

In an embodiment, the main memory may include a dynamic random access memory (DRAM) and the nonvolatile storage may include a NAND flash memory.

According to some example embodiments, a method of operating a storage system is provided. The method includes: loading information to a map table of a nonvolatile storage, the information including a logical address and a physical address corresponding to the logical address; transmitting the information to a host and storing the transmitted information in a main memory of the host; transmitting a request and the information from the host to a storage controller; and accessing the nonvolatile storage based on the request and the physical address transmitted from the host.

Accordingly, according to example embodiments, during an initialization process of a storage device, a logical address and a correlation index of a physical address corresponding to the logical address are transmitted to a host device, and the host device transmits to the storage device the logical address and the correlation index of the physical address corresponding to the logical address when accessing the host device. The storage controller of the storage device directly accesses a physical page corresponding to the correlation index transmitted from the host device, and thus operating speed of accessing the storage device may be increased.

### BRIEF DESCRIPTION OF THE DRAWINGS

Illustrative, non-limiting example embodiments will be more clearly understood from the following detailed description taken in conjunction with the accompanying drawings.

FIG. 1 is a block diagram illustrating a storage system according to some example embodiments.

FIG. 2 is a block diagram illustrating a host device in FIG. 1 according to some example embodiments.

FIG. 3 is a block diagram illustrating a storage controller in FIG. 1 according to some example embodiments.

FIG. 4 illustrates a register unit in FIG. 3 according to some example embodiments.

FIG. 5 illustrates a map table in FIG. 1 according to some example embodiments.

FIG. 6 illustrates an operation of the storage system of FIG. 1 according to some example embodiments.

FIG. 7 illustrates an update table in FIG. 4 according to some example embodiments.

FIG. 8 illustrates a write operation of the storage system of FIG. 1 according to some example embodiments.

FIG. 9 illustrates a read operation of the storage system of FIG. 1 according to some example embodiments.

FIG. 10 illustrates a connection relationship of the CPU, the main memory and the storage device in FIG. 1 according to some example embodiments.

FIG. 11 illustrates another connection relationship of the CPU, the main memory and the storage device in FIG. 1 according to some example embodiments.

FIG. 12 is a block diagram illustrating a nonvolatile storage in FIG. 1 according to some example embodiments.

FIGS. 13 through 16 are diagrams illustrating examples of memory cell arrays that are incorporated in the nonvolatile storage of FIG. 12.

FIG. 17 is a diagram illustrating an example of a spin-transfer torque magneto-resistive random access memory (STT-MRAM) cell in the memory cell array of FIG. 16.

FIG. 18 is a block diagram illustrating a memory card that is incorporated a storage device according to some example embodiments.

FIG. 19 is a diagram illustrating a solid state drive that is incorporated a storage device according to some example embodiments.

FIG. 20 is a flow chart illustrating a method of operating a storage system according to some example embodiments.

FIGS. 21 and 22 are block diagrams each illustrating a computing system that may incorporate a storage device according to some example embodiments.

### DETAILED DESCRIPTION OF THE EMBODIMENTS

Various example embodiments will now be described in some additional detail with reference to the accompanying drawings. The present disclosure may, however, be embodied in many different forms and should not be construed as being limited to only the illustrated embodiments. Throughout the written description and drawings, like reference numbers refer to like or similar elements and features.

It will be understood that, although the terms first, second, etc. may be used herein to describe various elements, these elements should not be limited by these terms. Unless indicated otherwise, these terms are used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments and is not intended to be limiting of the present disclosure. As used herein, the singular forms “a,” “an” and “the” are intended to include the plural forms as well, unless the context clearly indicates otherwise. It will be further understood that the terms such as “comprises,” “comprising,” “includes” and/or “including,” when used herein, specify the presence of stated features, integers, steps, operations, elements, and/or components, but do not preclude the presence or addition of one or more other.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, example embodiments will be described with reference to accompanying drawings. The same reference numerals will be used to refer to the same elements throughout the drawings and detailed description about the same elements will be omitted in order to avoid redundancy.

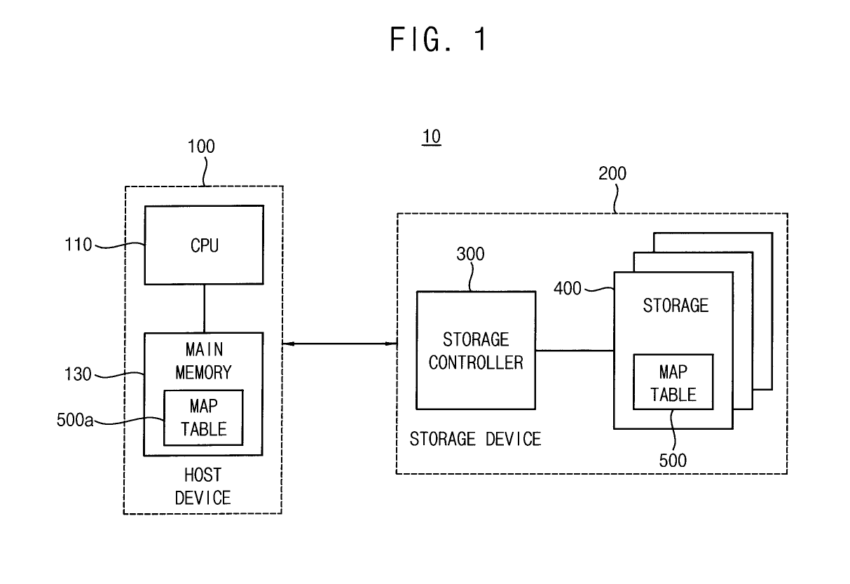

FIG. 1 is a block diagram illustrating a storage system according to some example embodiments.

Referring to FIG. 1, a storage system includes a host device 100 and a storage device 200.

The host device 100 may include a central processing unit (CPU) 110 and a main memory 130. The CPU 110 may control overall operation of the host device 100. The CPU 100 may be coupled to the main memory 130 through a system bus including an address bus, a control bus and/or a data bus. For example, the main memory 130 may be implemented by a dynamic random access memory (DRAM). In other examples, the main memory 130 may be implemented by, for example, a static random access memory (SRAM), a flash memory, a mobile DRAM, a phase random access memory (PRAM), a ferroelectric random access memory (FRAM), a resistive random access memory (RRAM), a magnetic random access memory (MRAM), etc. The CPU 110 may transmit a logical address and a correlation index based on contents of a map table 500a that are transmitted from the storage device 200 and are stored in the main memory 130 when accessing the storage device 200. Here, the logical address is an address used by the host device 100 when accessing the storage device 200, and the correlation index specifies a physical address corresponding to the logical address. That is, the correlation index may correlate a logical address with a physical address corresponding to the logical address.

The storage device 200 may include a storage controller 300 and a nonvolatile storage (or a nonvolatile memory device) 400. The nonvolatile storage may include a map table 500. The storage controller 300 receives a request from the host device 100 and controls operation of the storage device 200 in response to the request.

The nonvolatile storage 400 may store data provided from the host device 100 or may provide the host device 100 with stored data. The nonvolatile storage 400 maintains data when power supply is cut-off. The nonvolatile storage 400 may be implemented by, for example, NAND flash memory, NOR flash memory, PRAM, FRAM, RRAM, MRAM, etc.

The nonvolatile storage 400 may include the map table 500 that stores information including a logical address, a physical address corresponding to the logical address and a correlation index designating the physical address. During an initialization process of the storage device 200 (but, not limited to this operation), the information of the map table 500 may be stored in the map table 500a through the storage controller 300. In certain embodiments, when the host device 100 accesses the storage device 200, the host device 100 transmits to the storage device 200 a logical address and a correlation index of a physical address corresponding to the logical address. Accordingly, the storage controller 300 may directly access a physical page corresponding to the correlation index transmitted from the host device 100, and without accessing the map table 500 in the nonvolatile storage 400 and converting the logical address to a corresponding physical address. Therefore, operating speed of accessing the nonvolatile storage 400 may be increased.

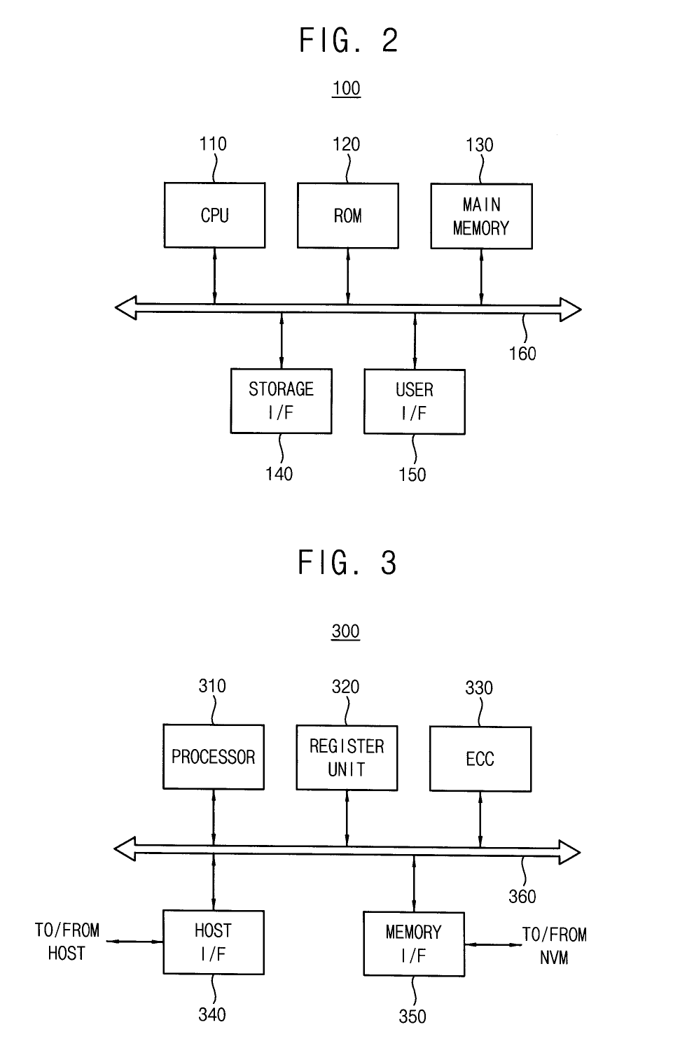

FIG. 2 is a block diagram illustrating a host device in FIG. 1 according to some example embodiments.

Referring to FIG. 2, the host device 100 includes a CPU 110, a ROM 120, a main memory 130, a storage interface 140, a user interface 150 and a bus 160.

The bus 160 may refer to a transmission channel via which data is transmitted between the CPU 100, the ROM 120, the main memory 130, the storage interface 140 and the user interface 150 of the host device 100.

The ROM 120 may store various application programs. For example, application programs supporting storage protocols such as Advanced Technology Attachment (ATA), Small Computer System Interface (SCSI), embedded Multi Media Card (eMMC), and Unix File System (UFS) protocols are stored.

The main memory 130 may temporarily store data or programs, and the contents of the map table 500 stored in the nonvolatile storage 400 may be loaded and stored in the map table 500a during the initialization process of the storage device 200.

The storage interface 140 may include an interface supporting a storage protocol, e.g., an Advanced Technology Attachment (ATA) interface, a Serial Advanced Technology Attachment (SATA) interface, a Parallel Advanced Technology Attachment (PATA) interface, a Universal Serial Bus (USB) or Serial Attached Small Computer System (SAS) interface, a Small Computer System Interface (SCSI), an embedded Multi Media Card (eMMC) interface, or a Unix File System (UFS) interface.

The user interface 150 may be a physical or virtual medium for exchanging information between a user and the host device 100, a computer program, etc., and includes physical hardware and logical software. For example, the user interface 150 may include an input device for allowing the user to manipulate the host device 100, and an output device for outputting a result of processing according to an input of the user.

The CPU 110 may control overall operations of the host device 100. The CPU may generate a request (or a command) for storing data in the storage device 200 or a request (or a command) for reading data from the storage device 200 by using an application stored in the ROM 120, and transmit the respective request to the storage device 200 via the storage interface 140.

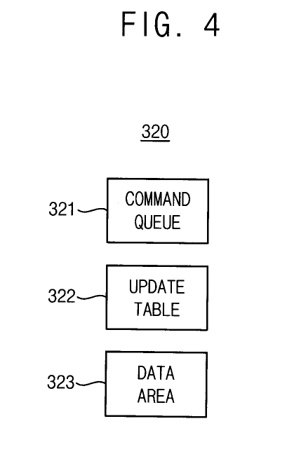

FIG. 3 is a block diagram illustrating a storage controller in FIG. 1 according to some example embodiments.

Referring to FIG. 3, the storage controller 300 includes a processor 310, a register unit 320, an error correction code (ECC) block 330, a host interface 340, a memory interface 350, and a bus 360.

The bus 360 may refer to a transmission channel via which data is transmitted between the processor 310, the register unit 320, the ECC block 330, the host interface 340 and the memory interface 350 of the storage controller 300.

The host interface 340 may include a protocol for exchanging data with the host device 100 that accesses the storage device 200, and connect the storage device 200 and the host device 100 to each other. The host interface 340 may be implemented using, but not limited to, an Advanced Technology Attachment (ATA) interface, a Serial Advanced Technology Attachment (SATA) interface, a Parallel Advanced Technology Attachment (PATA) interface, a Universal Serial Bus (USB) or Serial Attached Small Computer System (SAS) interface, a Small Computer System Interface (SCSI), an embedded Multi Media Card (eMMC) interface, or a Unix File System (UFS) interface. The processor 310 may communicate with the nonvolatile storage 400 through the memory interface 350.

The ECC block 330 may generate an error correction code (ECC) for data which is received from the host device 100 using an algorithm such as a Reed-Solomon (RS) code, a Hamming code, or a cyclic redundancy code (CRC) during a write operation. During a read operation, the ECC block 330 may perform error detection and error correction on data read from the nonvolatile storage 400 using the ECC read together with the data.

The storage controller 300 may be built-in in the nonvolatile storage 400, and the storage controller 300 and the nonvolatile storage 400 may be fabricated as separate chips. The ECC block 300 may be included in the nonvolatile storage 400 for reducing amount of data transmission between the nonvolatile storage 400 and the storage controller 300.

The storage device 200 may be implemented by, for example, a memory card or a solid state drive, etc.

The register unit 320 may store the command corresponding to the request from the host device 100, the logical address, the correlation index of the physical address corresponding to the logical address and data. The processor 310 may refer to contents stored in the register unit 320 when accessing the nonvolatile storage 400. The nonvolatile storage 400, the storage controller 300 and/or the storage device 200 may be packaged in various forms, such as package on package (PoP), ball grid arrays (BGAs), chip scale packages (CSPs), plastic leaded chip carrier (PLCC), plastic dual in-line package (PDIP), die in waffle pack, die in wafer form, chip on board (COB), ceramic dual in-line package (CERDIP), plastic metric quad flat pack (MQFP), thin quad flat pack (TQFP), small outline IC (SOIC), shrink small outline package (SSOP), thin small outline package (TSOP), system in package (SIP), multi chip package (MCP), wafer-level fabricated package (WFP), or wafer-level processed stack package (WSP).

In one embodiment, when a power is applied to the storage device 200, the processor 310 controls the storage device 200 such that the contents of the map table 500 of the nonvolatile storage are stored in the register unit 320 during the initialization process. The processor 310 may transmit a message to the host device 100 such that the contents of the map table stored in the register unit 320 are loaded to the main memory 130 of the host device 100. In addition, the processor 310 may control the storage device 200 such that corresponding contents stored in the register unit 320 are updated when the nonvolatile storage 400 changes the contents of the map table 500. In addition, the processor 310 may control the storage device 200 such that the contents stored in the register unit 320 are written in the nonvolatile storage 400 before power is cut-off from the storage device 200. The processor 310 may include firmware built therein for performing above-described operation.

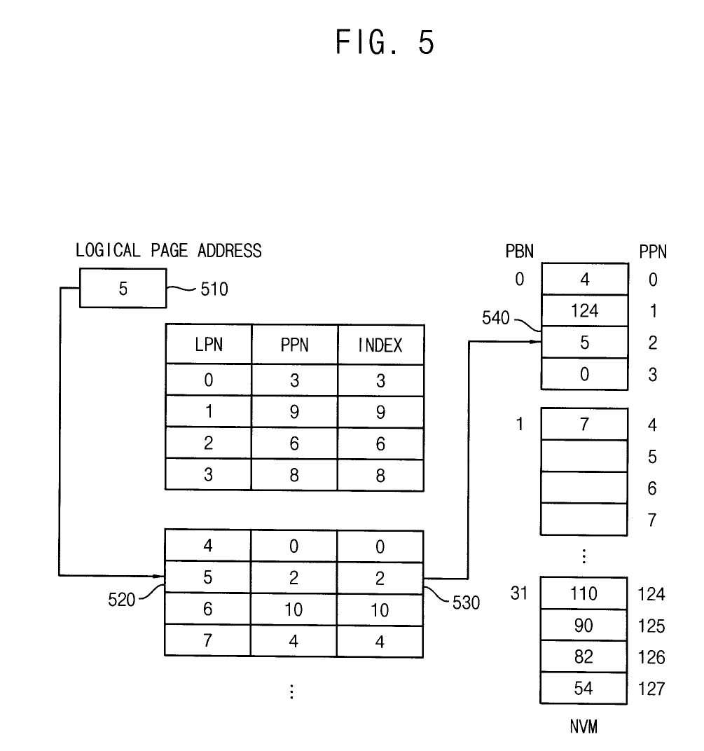

FIG. 4 illustrates the register unit in FIG. 3 according to some example embodiments.

Referring to FIG. 4, the register unit 320 includes a command queue 321, an update table 322 and a data area 323.

The command queue 321 may store commands corresponding the requests from the host device 100 sequentially or according to priority. The data area 323 may temporarily store write data from the host device 100 or read data from the nonvolatile storage 400. The update table 322 may store a physical address corresponding to the logical address transmitted from the host device 100, a correlation index of the physical address and a valid tag representing whether the physical address is valid and/or whether the physical address is updated.

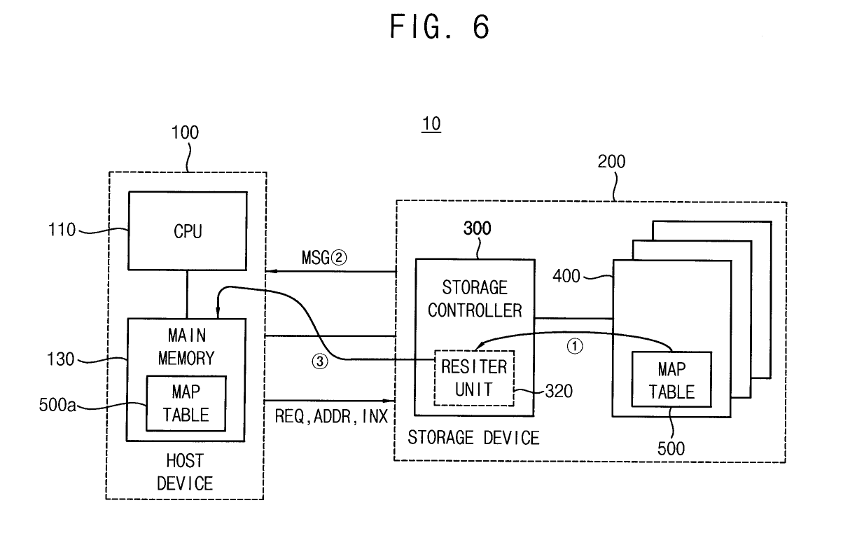

FIG. 5 illustrates the map table in FIG. 1 according to some example embodiments.

In FIG. 5, memory block of the nonvolatile storage 400 in FIG. 1 is altogether illustrated for convenience. In addition, FIG. 5 illustrates an example of the map table 500 or the map table 500a based on page mapping scheme.

In FIG. 5, it is assumed that the host device 100 is to access a physical page address corresponding to a logical page address ‘5’. When the host device 100 accesses the logical page address ‘5’ as represented by a reference numeral 510, the CPU 110 searches an entry 530 corresponding to an entry 520 storing the logical page address ‘5’ and transmits to the storage device 200 the logical page address ‘5’ and a correlation index ‘2’ of a physical page address ‘2’ corresponding to the logical page address ‘5’. For example, a correlation index may be the same as a corresponding physical address. The storage controller 300 accesses a physical page 540 designated by the physical page address ‘2’ based on the correlation index ‘2’ of the physical page address ‘2’ corresponding to the logical page address ‘5’.

In FIG. 5, it is assumed that the nonvolatile storage 400 includes 32 page blocks and each of the page blocks includes 4 physical pages (i.e., 4 physical page addresses). In some embodiments, the nonvolatile storage 400 may include not less than 64 page blocks and one page block may include 8, 16, 32 or 64 physical pages. In some embodiments, the map table 500 or the map table 500a may be formed according to a block mapping scheme or a hybrid mapping scheme.

In one embodiment, when the map table 500 or the map table 500a is formed according to the block mapping scheme, a physical block corresponding to one logical block may be dynamically changed, however location of a page (that is, a page offset) is maintained.

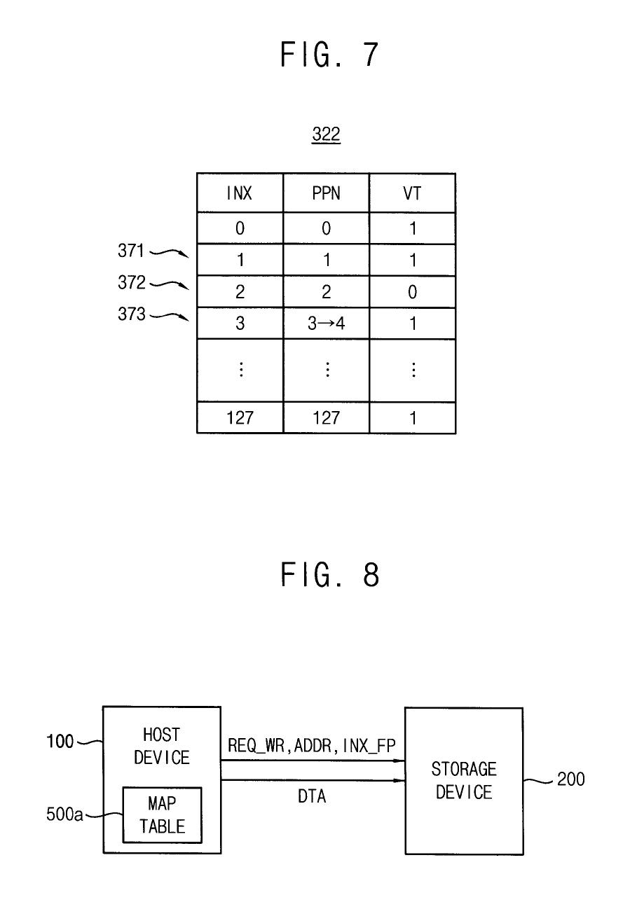

FIG. 6 illustrates an operation of the storage system of FIG. 1 according to some example embodiments.

Referring to FIGS. 1 through 3 and 6, when a power is applied to the storage device 200, the processor 310 controls the storage device 200 such that the contents of the map table 500 are stored in the register unit 320 during the initialization process of the storage device 200 as a reference numeral \textcircled{1} indicated. The processor 310 transmits a message MSG to the host device 100 as a reference numeral \textcircled{2} indicated such that the contents of the map table stored in the register unit 320 are loaded to the main memory 130 of the host device 100. In one embodiment, when accessing the storage device 200, the host device 100 (or the CPU 110) transmits to the storage device 200 a request REQ, a logical address ADDR and a correlation index INX of a physical address corresponding to the logical address ADDR as a reference numeral \textcircled{3} indicated by referring to the map table 500a of the host device 100. In another embodiment, when accessing the storage device 200, the host device 100 transmits to the storage device 200 a request REQ, a logical address ADDR and a physical address corresponding to the logical address ADDR as a reference numeral \textcircled{3} indicated by referring to the map table 500a of the host device 100. The storage controller 300 may directly access a physical page based on the correlation index INX of the physical address corresponding to the logical address ADDR.

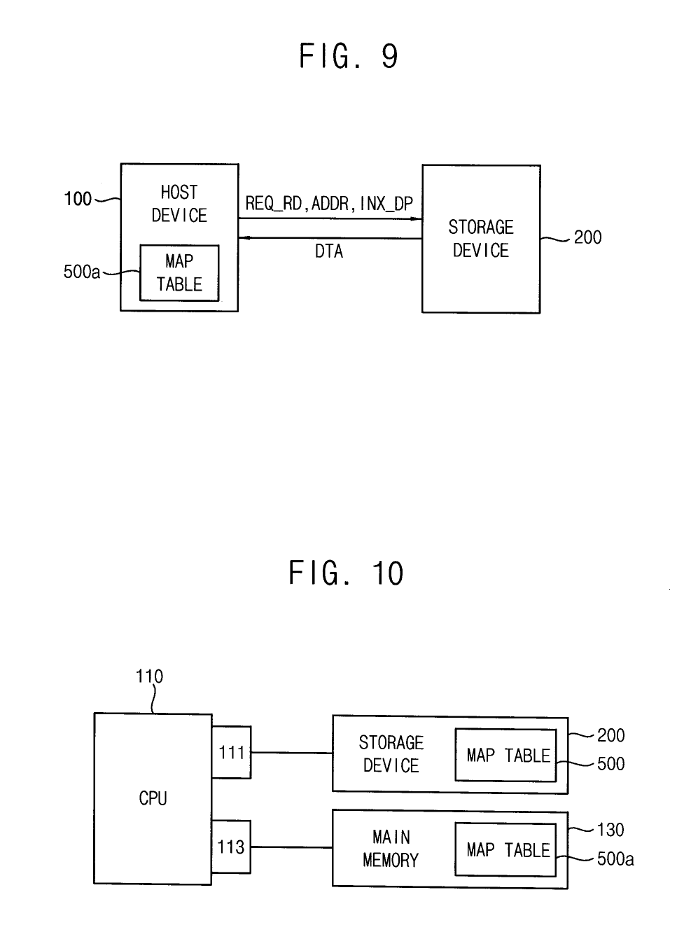

FIG. 7 illustrates the update table in FIG. 4 according to some example embodiments.

Referring to FIG. 7, the update table 322 may store as entries a correlation index INX, a physical page number PPN and a valid tag VT representing whether a physical page number PPN is valid and/or whether the physical page number PPN is updated.

As a reference numeral 371 indicates, a correlation index INX ‘1’ may designate a physical page corresponding to a physical page number PPN ‘1’ and the physical page number PPN ‘1’ is valid because a valid tag VT of the physical page number PPN ‘1’ is high level. As a reference numeral 372 indicates, a correlation index INX ‘2’ may designate a physical page corresponding to a physical page number PPN ‘2’ and the physical page number PPN ‘2’ is invalid because a valid tag VT of the physical page number PPN ‘2’ is a low level. As a reference numeral 373 indicates, a physical page number PPN corresponding to a correlation index INX ‘3’ is updated from ‘3’ to ‘4’ and the physical page number PPN ‘4’ is valid because a valid tag VT of the physical page number PPN ‘4’ is high level. The processor 310 may perform updating operation on the update table 322. In this case, the correlation index INX ‘3’ corresponds to the physical page number PPN ‘4.’

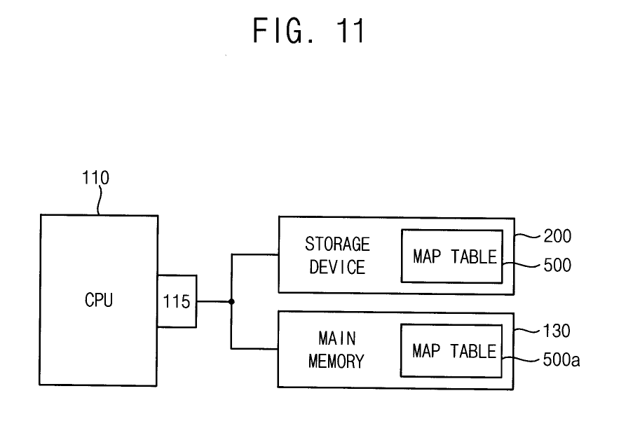

FIG. 8 illustrates a write operation of the storage system of FIG. 1 according to some example embodiments.

Referring to FIGS. 1 and 8, in one embodiment, when the host device 100 writes data to the storage device 200, the host device 100 refers to the map table 500a and provides the storage device 200 with a write request REQ_WR, a logical address ADDR, data DTA and a correlation index of a free page INX_FP (or a physical address corresponding to the logical address). The storage controller 300 writes data DTA to a physical page corresponding to the correlation index of the free page INX_FP in the nonvolatile storage 400.

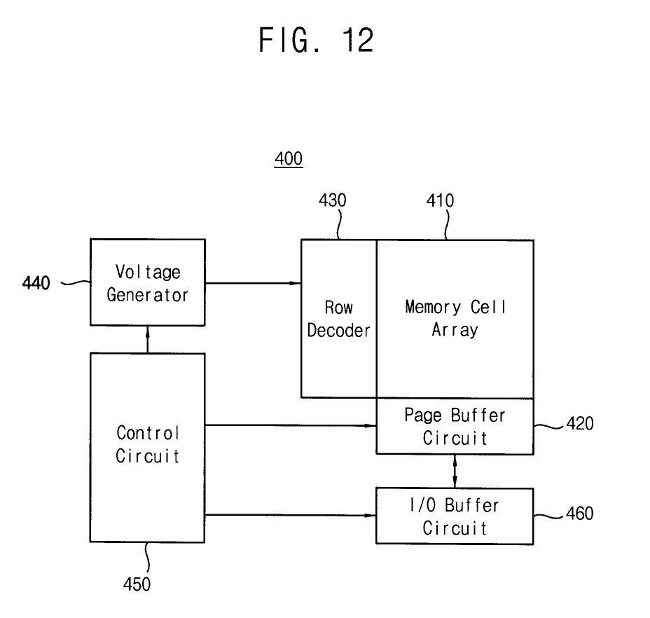

FIG. 9 illustrates a read operation of the storage system of FIG. 1 according to some example embodiments.

Referring to FIGS. 1 and 9, when the host device 100 reads data from the storage device 200, the host device 100 refers to the map table 500a and provides the storage device 200 with a read request REQ_RD, a logical address ADDR and a correlation index of a data page INX_DP (or a physical address corresponding to the logical address). The storage controller 300 reads data DTA from a physical page corresponding to the correlation index of the data page INX_DP in the nonvolatile storage 400 and provides the data DTA to the host device 100.

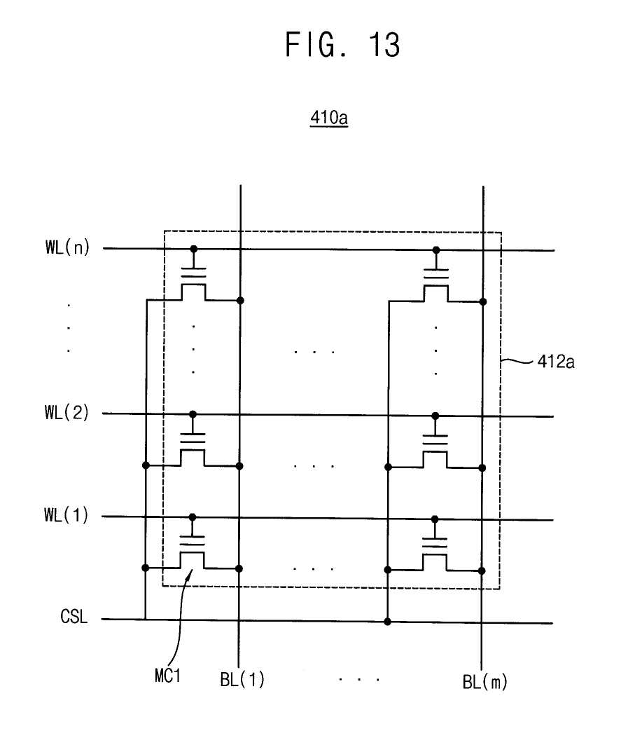

FIG. 10 illustrates a connection relationship of the CPU, the main memory and the storage device in FIG. 1 according to some example embodiments.

Referring to FIGS. 1 and 10, the CPU 110 of the host device 100 is coupled to the storage device 200 through a first interface 111 and is coupled to the main memory 130 through a second interface 113. For example, the CPU 110 is respectively coupled to the storage device 200 and the main memory 130 through individual interfaces. In this case, the contents of the map table 500 in the storage device 200 is loaded to the map table 500a in the main memory 130 through the first interface 111, the CPU 110 and the second interface 113. When accessing the storage device 200, the CPU 110 transmits to the storage device 200 a logical address and a correlation index of a physical address corresponding to the access logical address, and the storage controller 300 directly accesses the nonvolatile storage 400 based on the correlation index of the physical address corresponding to the logical address.

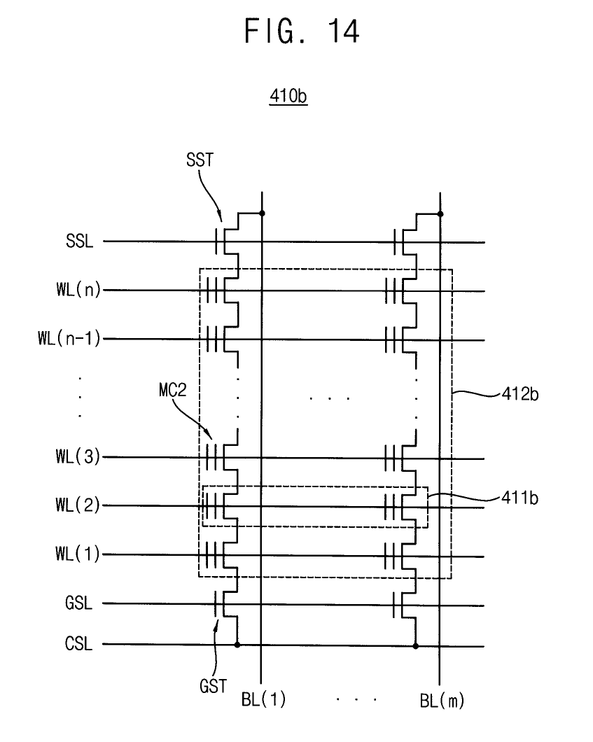

FIG. 11 illustrates another connection relationship of the CPU, the main memory and the storage device in FIG. 1 according to some example embodiments.

Referring to FIGS. 1 and 11, in one embodiment, the CPU 110 of the host device 100 is coupled to the storage device 200 and the main memory through a common interface 115. For example, the CPU 110 may be commonly coupled to the storage device 200 and the main memory 130 through one common interface. In this case, the contents of the map table 500 in the storage device 200 are loaded to the map table 500a in the main memory 130 through the common interface 115, the CPU 110 and the common interface 115. When accessing the storage device 200, the CPU 110 transmits to the storage device 200 a logical address and a correlation index of a physical address corresponding to the logical address, and the storage controller directly accesses the nonvolatile storage 400 based on the correlation index of the physical address corresponding to the logical address.

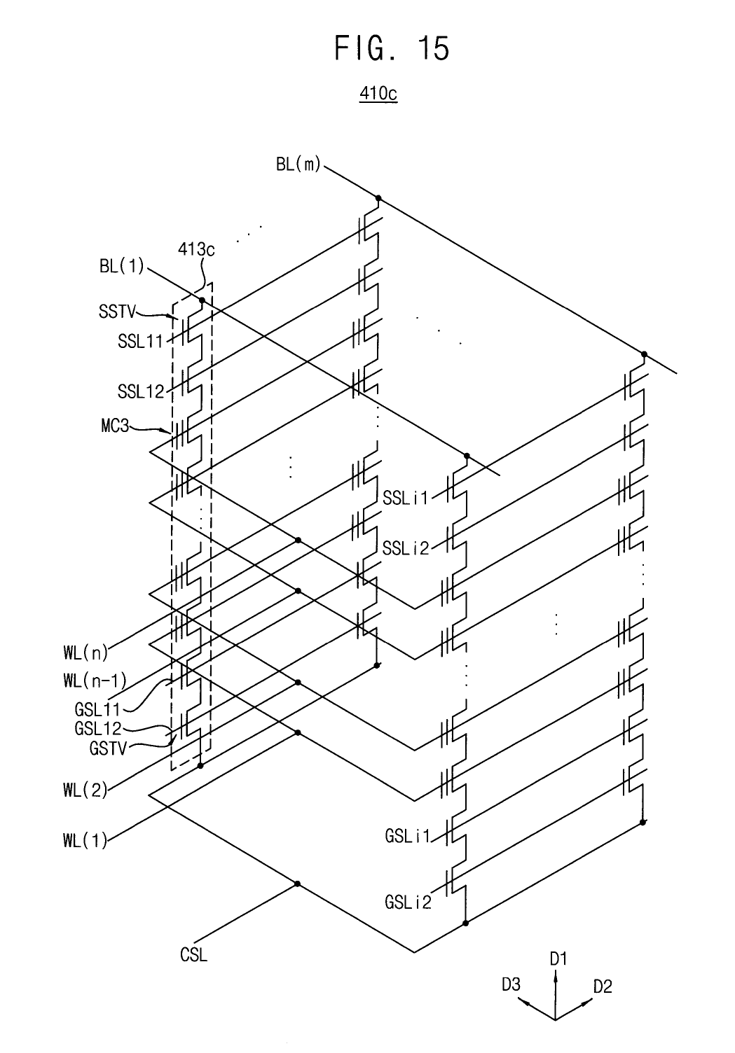

FIG. 12 is a block diagram illustrating the nonvolatile storage in FIG. 1 according to some example embodiments.

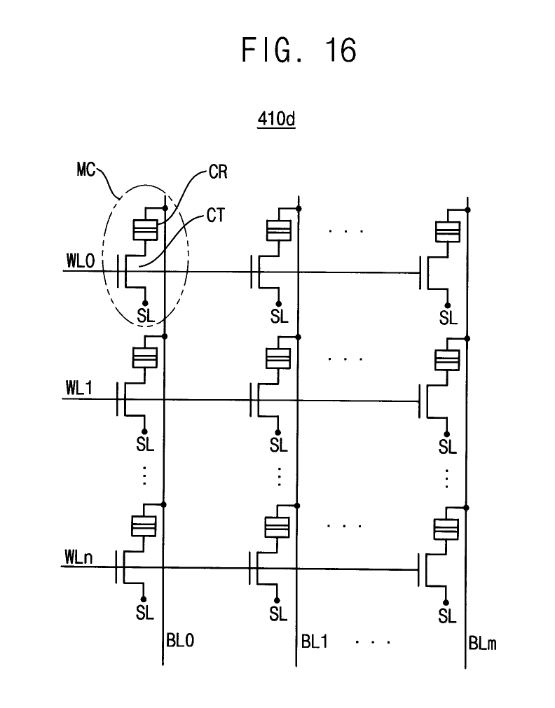

Referring to FIG. 12, the nonvolatile storage 400 includes a memory cell array 410, a page buffer circuit 420, a row decoder 430, a voltage generator 440, a control circuit 450 and an input/output (I/O) buffer circuit 460. The nonvolatile storage 400 may be implemented by, for example, flash memory device, PRAM, FRAM, RRAM, MRAM, etc. The memory cell array 410 includes a plurality of memory cells connected to a plurality of word lines and a plurality of bit lines. As will be described below with reference to FIGS. 13 to 16, each of the memory cells may include a NAND, NOR flash memory cell or resistive memory cell, and the memory cells may be arranged in a two-dimensional array structure or a three-dimensional array structure.

In the example embodiments, each of the memory cells may include, for example, a single level memory cell (SLC) for storing one data bit and a multi-level memory cell (MLC) for storing a plurality data bits. In a case of the MLC, a program scheme in a write mode may include various program schemes such as a shadow program scheme, a reprogram scheme, or an on-chip buffered program scheme.

The page buffer circuit 420 is connected to the bit lines and is controlled by the control circuit 450 and serves as a sense amplifier or a write driver according an operation mode. For example, during a read operation, the page buffer circuit 420 operates as the sense amplifier for sensing data from memory cells in a selected row. During a program operation, the page buffer circuit 420 may operate as a write driver for driving memory cells in a selected row according to program data. The page buffer circuit 420 may include page buffers corresponding to bit lines or bit line pairs, respectively. The I/O buffer circuit 460 receives write data from the storage controller 300 and transmits read data to the storage controller 300.

The row decoder 430 is connected to the word lines and may select at least one of the word lines in response to a row address. The voltage generator 440 may generate word line voltages such as a program voltage, a pass voltage, a verification voltage, an erase voltage and a read-out voltage according to a control of the control circuit 450. The control circuit 450 may control the page buffer circuit 420, the row decoder 430 and the voltage generator 440 in order to perform the data storing, erasing and read-out operations with respect to the memory cell array 410.

FIGS. 13 through 16 are diagrams illustrating examples of memory cell arrays that are incorporated in the nonvolatile storage of FIG. 12.

FIG. 13 is a circuit diagram illustrating a memory cell array included in a NOR flash memory device. FIG. 14 is a circuit diagram illustrating a memory cell array included in a NAND flash memory device. FIG. 15 is a circuit diagram illustrating a memory cell array included in a vertical flash memory device. FIG. 16 is a circuit diagram illustrating a memory cell array in a resistive memory device.

Referring to FIG. 13, an exemplary memory cell array 410a includes a plurality of memory cells MC1. Memory cells in the same column may be connected in parallel between one of bit-lines BL(1), . . . , BL(m) and a common source line CSL. Memory cells in the same row may be commonly connected to the same word-line among word-lines WL(1), . . . , WL(n). For example, memory cells in a first column may be connected in parallel between a first bit-line BL(1) and the common source line CSL. Memory cells in a first row may be commonly connected to a first word-line WL(1). The memory cells MC1 may be controlled by a voltage on the word-lines WL(1), . . . , WL(n). In the NOR flash memory device including the memory cell array 410a, a read operation and a program operation may be performed per byte or word, and an erase operation may be performed per block 412a.

The map table 500 may be stored some portion of the memory cell array 410a and the contents of the map table 500 may be transmitted to the main memory 130 during the initialization process.

Referring to FIG. 14, the memory cell array 410b may include string select transistors SST, ground select transistors GST and a plurality of memory cells MC2. The string select transistors SST may be connected to bit-lines BL(1), . . . , BL(m), and the ground select transistors GST may be connected to a common source line CSL. The memory cells MC2 may be connected in series between the string select transistors SST and the ground select transistors GST. Memory cells in the same row may be connected to the same word-line among word-lines WL(1), . . . , WL(n). For example, 16, 32 or 64 word-lines may be disposed between a string select line SSL and a ground select line GSL.

The string select transistors SST may be connected to the string select line SSL, and may be controlled by a voltage on the string select line SSL. The ground select transistors GST may be connected to the ground select line GSL, and may be controlled by a voltage on the ground select line GSL. The memory cells MC2 may be controlled by a voltage on the word-lines WL(1), . . . , WL(n).

In the NAND flash memory device including the memory cell array 410b, a read operation and a program operation may be performed per page 411b, and an erase operation may be performed per block 412b. In this case, the odd-numbered bit-lines may form odd-numbered pages, the even-numbered bit-lines may form even-numbered pages, and program operations for the odd-numbered pages and the even-numbered pages may be alternately performed.

The map table 500 may be stored some portion of the memory cell array 410b and the contents of the map table 500 may be transmitted to the main memory 130 during the initialization process.

Referring to FIG. 15, a memory cell array 410c may include a plurality of strings 413c each of which has a vertical structure. The plurality of strings 413c may be formed in a second direction D2 to define a string column, and a plurality of string columns may be formed in a third direction D3 to define a string array. Each string may include string select transistors SSTV, ground select transistors GSTV, and a plurality of memory cells MC3 that are formed in a first direction D1 and are connected in series between the string select transistors SSTV and the ground select transistors GSTV.

The string select transistors SSTV may be connected to bit-lines BL(1), . . . , BL(m), and the ground select transistors GST may be connected to a common source line CSL. The string select transistors SSTV may be connected to string select lines SSL11, SSL12, . . . , SSLi1, SSLi2, and the ground select transistors GSTV may be connected to ground select lines GSL11, GSL12, . . . , GSLi1, GSLi2. The memory cells in the same layer may be connected to the same word-line among word-lines WL(1), WL(2), . . . WL(n−1), WL(n). Each string select line and each ground select line may extend in the second direction D2, and the string select lines SSL11, . . . , SSLi2 and the ground select lines GSL11, . . . , GSLi2 may be formed in the third direction D3. Each word-line may extend in the second direction D2, and the word-lines WL(1), . . . , WL(n) may be formed in the first direction D1 and the third direction D3. Each bit-line may extend in the third direction D3, and the bit-lines BL(1), . . . , BL(m) may be formed in the second direction D2. The memory cells MC3 may be controlled by a voltage on the word-lines WL(1), . . . , WL(n).

Similarly to the NAND flash memory device, in the vertical flash memory device including the memory cell array 410c, a read operation and a program operation may be performed per page, and an erase operation may be performed per block.

Although not illustrated in FIG. 15, according to example embodiments, two string select transistors included in a single string may be connected to a single string select line, and two ground select transistors included in the single string may be connected to a single ground select line. According to example embodiments, the single string may include one string select transistor and one ground select transistor.

The map table 500 may be stored some portion of the memory cell array 410c and the contents of the map table 500 may be transmitted to the main memory 130 during the initialization process.

Referring to FIG. 16, a memory cell array 410d includes a plurality of word lines WL0˜WLn, a plurality of bit lines BL0˜BLm and a plurality of memory cells MC respectively disposed in cross areas of the word lines WL0˜WLn and the bit lines BL0˜BLm. For example, when the memory cell MC is implemented with an STT-MRAM cell, each memory cell MC may include a magnetic tunnel junction (MTJ) element of magnetic materials.

A cell transistor and a MTJ element in each memory cell MC are coupled between a source line SL and one of the bit lines BL0˜BLm. Even though not illustrated in FIG. 16, a plurality of memory cells may be coupled to the common source line. In some embodiments, the memory cell array 410d may be partitioned to at least two cell regions and the cell regions may be coupled to the different source lines.

The map table 500 may be stored some portion of the memory cell array 410d and the contents of the map table 500 may be transmitted to the main memory 130 during the initialization process.

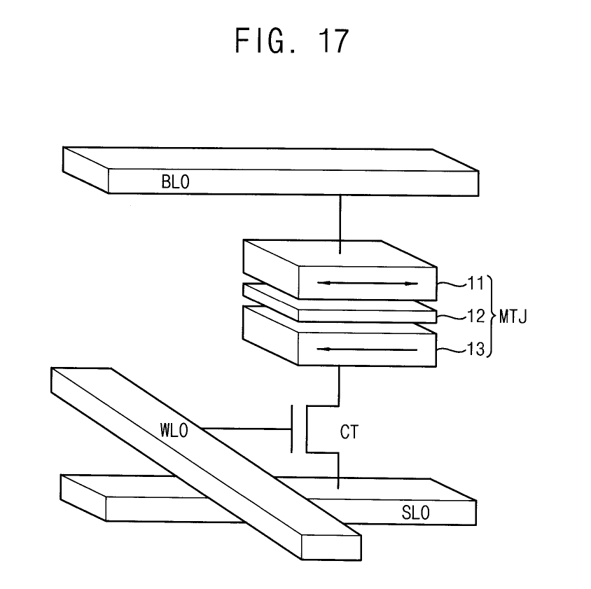

FIG. 17 is a diagram illustrating an example of a spin-transfer torque magneto-resistive random access memory (STT-MRAM) cell in the memory cell array of FIG. 16.

Referring to FIG. 17, the STT-MRAM cell may include an MTJ element MTJ and a cell transistor CT. A gate of the cell transistor CT is coupled to a corresponding word line WL0, a first electrode of the cell transistor CT is coupled to a corresponding bit line BL0 via the MTJ element 420, and a second electrode of the cell transistor CT is coupled to a source line SL0.

The MTJ element MTJ may include a pinned layer 13, a free layer 11 and a barrier layer 12 between the two layers 11 and 13. The magnetization direction of the pinned layer 13 is fixed but the magnetization direction of the free layer 11 may be varied, according to the written data, between the same direction as or opposite direction to the magnetization direction of the pinned layer 13. In one embodiment, an anti-ferromagnetic layer may be further included in the MTJ element MTJ to enforce the magnetization direction of the pinned layer 13.

For example, to perform the write operation of the STT-MRAM cell, a high level voltage is applied to the word line WL0 to turn on the cell transistor CT, a write current is applied to flow from the bit line BL0 to the source line SL0.

For example, to perform the read operation of the STT-MRAM cell, a high level voltage is applied to the word line WL0 to turn on the cell transistor CT, a read current is applied to flow from the bit line BL0 to the source line SL0, and the resistance value is measured to determine the data stored in the MTJ element 420.

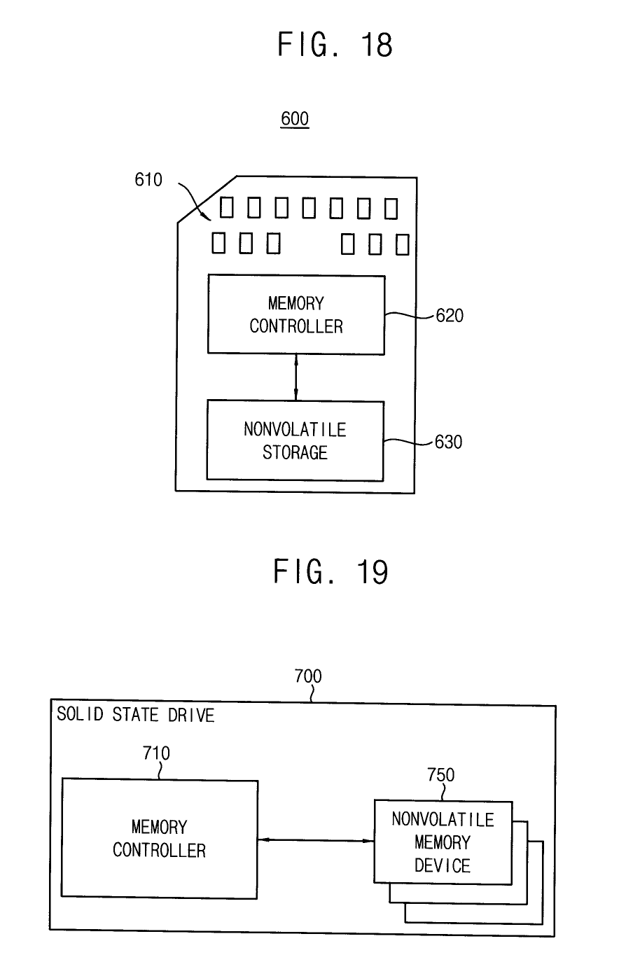

FIG. 18 is a block diagram illustrating a memory card that is incorporated a storage device according to some example embodiments.

Referring to FIG. 18, a memory card 600 may include a plurality of connecting pins 610, the storage device (e.g., a memory controller 620 and a nonvolatile storage 630).

The connecting pins 610 may be coupled to the host device 100 to transfer signals between the host and the memory card 600. The connecting pins 610 may include a clock pin, a command pin, a data pin and/or a reset pin.

The memory controller 620 may receive data from the host device 100, and may store the received data in the nonvolatile storage 630.

The nonvolatile storage 630 may include a map table that stores information including a logical address, a physical address corresponding to the logical address and a correlation index designating the physical address. During an initialization process of the storage device 630, the contents of the map table may be stored in the map table of the host device 100 through the memory controller 620. When the host device 100 accesses the memory card 600, the host device 100 transmits to the memory card 600 a logical address and a correlation index of a physical address corresponding to the logical address. The memory controller 620 directly accesses a physical page corresponding to the correlation index transmitted from the host device 100, and without accessing the map table of the nonvolatile storage 630 and converting the logical address to a corresponding physical address. Therefore, operating speed of accessing the nonvolatile storage may be increased.

For example, the memory card 600 may include, for example, a MMC, an embedded MMC (eMMC), a hybrid embedded MMC (hybrid eMMC), a secure digital (SD) card, a micro-SD card, a memory stick, an ID card, a personal computer memory card international association (PCMCIA) card, a chip card, a USB card, a smart card, a compact flash (CF) card, etc.

The memory card 600 may be coupled to a host, such as a desktop computer, a laptop computer, a tablet computer, a mobile phone, a smart phone, a music player, a personal digital assistants (PDA), a portable multimedia player (PMP), a digital television, a digital camera, a portable game console, etc.

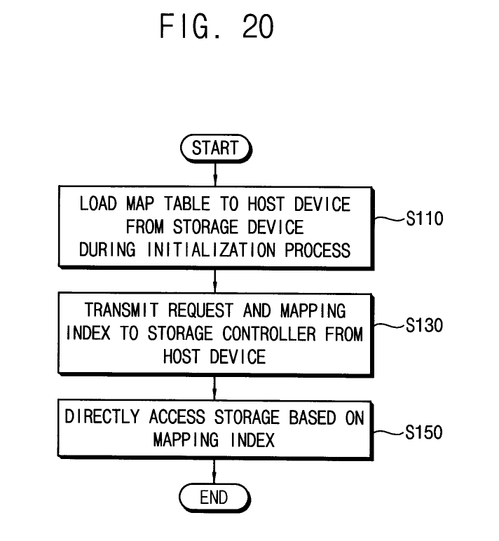

FIG. 19 is a diagram illustrating a solid state drive that is incorporated a storage device according to some example embodiments.

Referring to FIG. 19, a solid state drive (SSD) 700 includes a memory controller (or a storage controller) 710 and a plurality of nonvolatile memory devices (or nonvolatile storages) 750.

The memory controller 710 may receive data from the host device 100. The memory controller 710 may store the received data in the plurality of nonvolatile memory devices 750.

Each of the nonvolatile memory devices 750 may include a map table that stores information including a logical address, a physical address corresponding to the logical address and a correlation index designating the physical address. During an initialization process of the solid state drive 700, the information of the map table may be stored in the map table of the host device 100 through the memory controller 710. When the host device 100 accesses the solid state drive 700, the host device 100 transmits to the SSD 700 a logical address and a correlation index of a physical address corresponding to the logical address. The memory controller 710 directly accesses a physical page corresponding to the correlation index transmitted from the host device 100, and without accessing the map table of the nonvolatile memory devices 750 and converting the logical address to a corresponding physical address. Therefore, operating speed of accessing the nonvolatile memory devices 750 may be increased.

In some embodiments, the solid state drive 700 may be coupled to a host, such as a mobile device, a mobile phone, a smart phone, a PDA, a PMP, a digital camera, a portable game console, a music player, a desktop computer, a notebook computer, a tablet computer, a speaker, a video, a digital television, etc.

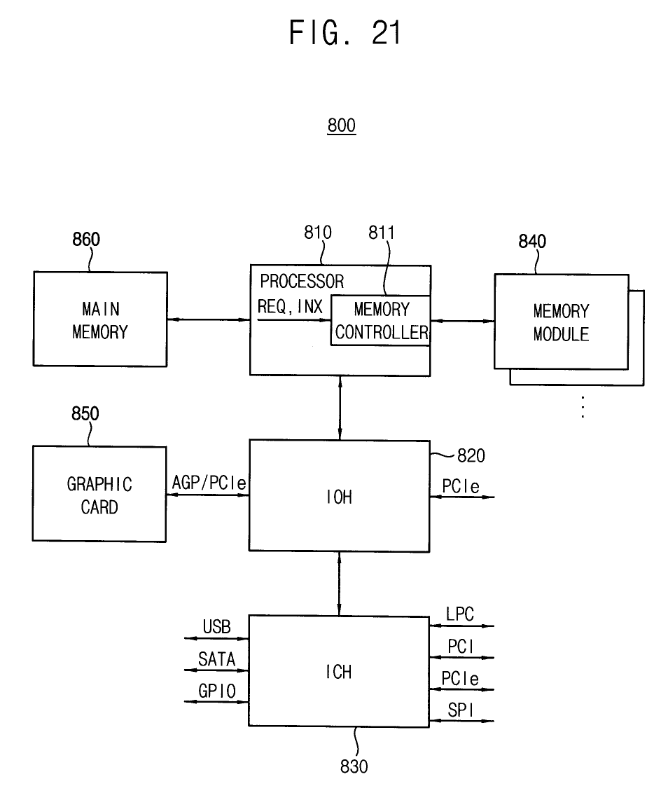

FIG. 20 is a flow chart illustrating a method of operating a storage system according to some example embodiments.

Referring to FIGS. 1 and 20, during an initialization process of the storage device 200, the contents of the map table 500 may be loaded in the map table 500a through the storage controller 300 (S110). When the host device 100 accesses the storage device 200, the host device 100 transmits to the storage device 200 a logical address and a correlation index of a physical address corresponding to the logical address (S130). The storage controller 300 directly accesses a physical page corresponding to the correlation index (S150). Therefore, without accessing the map table 500 of the nonvolatile storage 400 based on the correlation index transmitted from the host device 100 and converting the logical address to a corresponding physical address, the storage controller 300 directly accesses the physical pages and thus operating speed of accessing the nonvolatile storage 400 may be increased.

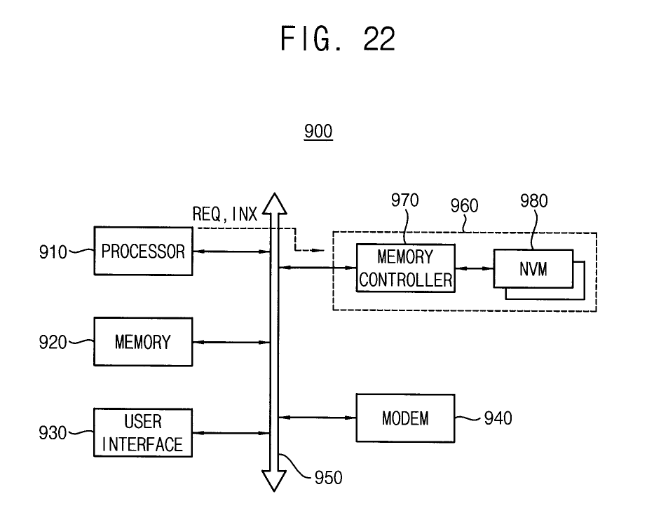

FIGS. 21 and 22 are block diagrams each illustrating a computing system that may incorporate a storage device according to some example embodiments.

Referring to FIG. 21, a computing system 800 includes a processor 810, an I/O hub 820, an I/O controller hub 830, at least one memory module 840 and a graphic card 850. According to example embodiments, the computing system 800 may be any computing system, such as a personal computer (PC), a server computer, a workstation, a tablet computer, a laptop computer, a mobile phone, a smart phone, a PDA, a PMP, a digital camera, a digital television, a set-top box, a music player, a portable game console, a navigation device, etc.

The processor 810 may perform specific calculations or tasks. For example, the processor 810 may be, for example, a microprocessor, a central process unit (CPU), a digital signal processor, or the like. The processor 810 may include a single processor core or a plurality of processor cores. The processor 810 may be a multi-core processor, such as a dual-core processor, a quad-core processor, a hexa-core processor, etc. Although the example illustrated in FIG. 21 includes only one processor 810, other embodiments may include a plurality of processors. In certain embodiments, the processor 810 may further include a cache memory located inside or outside the processor 810.

The processor 810 may include a memory controller (not illustrated) that controls an operation of the memory module 840. The memory controller included in the processor 810 may be referred to as an integrated memory controller (IMC). A memory interface between the memory controller and the memory module 840 may be implemented by one channel including a plurality of signal lines, or by a plurality of channels. Each channel may be coupled to at least one memory module 840. The memory controller may be included in the I/O hub 820. The I/O hub 820 including the memory controller may be referred to as a memory controller hub (MCH).

The memory module 840 may include a plurality of nonvolatile memory devices that store data provided from the memory controller 811. The nonvolatile memory devices each includes a map table that stores information including a logical address, a physical address corresponding to the logical address and a correlation index designating the physical address. During an initialization process of the memory module, the information of the map table may be stored in the map table of the main memory 860 through the memory controller 811. When the processor 810 accesses the memory module 840, the processor 810 transmits to the memory controller 811 a request REQ, a logical address and a correlation index INX of a physical address corresponding to the logical address. The memory controller 811 directly accesses a physical page corresponding to the correlation index transmitted from the processor 810, and without accessing each map table of the nonvolatile memory devices and converting the logical address to a corresponding physical address. Therefore, operating speed of accessing the memory module 840 may be increased.

The I/O hub 820 may manage data transfer between the processor 810 and devices, such as the graphic card 850. The I/O hub 820 may be coupled to the processor 810 via at least one of various interfaces, such as a front side bus (FSB), a system bus, a HyperTransport, a lightning data transport (LDT), a QuickPath interconnect (QPI), a common system interface (CSI), etc. Although FIG. 22 illustrates an example of the computing system 800 including one I/O hub 820, according to embodiments, the computing system 800 may include a plurality of I/O hubs.

The I/O hub 820 may provide various interfaces with the devices. For example, the I/O hub 820 may provide an accelerated graphics port (AGP) interface, a peripheral component interface-express (PCIe), a communications streaming architecture (CSA) interface, etc.

The graphic card 850 may be coupled to the I/O hub 820 via the AGP or the PCIe. The graphic card 850 may control a display device (not illustrated) for displaying an image. The graphic card 850 may include an internal processor and an internal memory to process the image. In certain embodiments, the input/output hub 820 may include an internal graphic device along with or instead of the graphic card 850. The internal graphic device may be referred to as an integrated graphics, and an I/O hub including the memory controller and the internal graphic device may be referred to as a graphics and memory controller hub (GMCH).

The I/O controller hub 830 may perform data buffering and interface arbitration to efficiently operate various system interfaces. The I/O controller hub 830 may be coupled to the I/O hub 820 via an internal bus. For example, the I/O controller hub 830 may be coupled to the I/O hub 820 via at least one of various interfaces, such as a direct media interface (DMI), a hub interface, an enterprise Southbridge interface (ESI), PCIe, etc.

The I/O controller hub 830 may provide various interfaces with peripheral devices. For example, the I/O controller hub 830 may provide a universal serial bus (USB) port, a serial advanced technology attachment (SATA) port, a general purpose input/output (GPIO), a low pin count (LPC) bus, a serial peripheral interface (SPI), a PCI, a PCIe, etc.

In certain embodiments, the processor 810, the I/O hub 820 and the I/O controller hub 830 may be implemented as separate chipsets or separate integrated circuits. In other embodiments, at least two of the processor 810, the I/O hub 820 and the I/O controller hub 830 may be implemented as one chipset.

Referring to FIG. 22, a computing system 900 includes a processor 910, a memory device 920, a user interface 930, a modem 940, a bus 950 and a memory system 960. The memory system 960 includes a memory controller 970 and a nonvolatile memory device 980.

The processor 910 may execute applications, such as an internet browser, a game application, a video player application, etc. The processor 910 may include a single processor core or a plurality of processor cores. For example, the processor 910 may be a multi-core processor, such as a dual-core processor, a quad-core processor, a hexa-core processor, etc. The processor 910 may further include a cache memory located inside or outside the processor 910. The processor 910 may be coupled to the memory system 960 through the bus 950 such as address bus, control bus and/or data bus. The modem 940 wirelessly receives or transmits data with an external device. The memory device 920 may serve as a main memory. For example, the memory device 920 may be implemented by a DRAM, a SRAM, a mobile DRAM, or the like. The nonvolatile memory device 980 may store an instruction/data processed by the processor 910, or store data received via the modem 940 through the memory controller 970.

The nonvolatile memory device 980 includes a map table that stores information including a logical address, a physical address corresponding to the logical address and a correlation index designating the physical address. During an initialization process of the memory system 960 the information of the map table may be stored in the map table of the memory device 920 through the memory controller 970. When the processor 910 accesses the nonvolatile memory device 980, the processor 910 transmits to the memory controller 970 a request REQ, a logical address and a correlation index INX of a physical address corresponding to the logical address. The memory controller 970 directly accesses a physical page corresponding to the correlation index transmitted from the processor 910, and without accessing the map table of the nonvolatile memory device 980 and converting the logical address to a corresponding physical address. Therefore, operating speed of accessing the memory system 960 may be increased.

The computing system 900 may further include a power supply that provides operating voltage. The computing system 900 may further include an application chipset and a camera image processor.

As mentioned above, according to example embodiments, during an initialization process of a storage device, a logical address and a correlation index of a physical address corresponding to the logical address are transmitted to a host device, and the host device transmits to the storage device the logical address and the correlation index of a physical address corresponding to the logical address when accessing the host device. The storage controller of the storage device directly accesses a physical page corresponding to the correlation index, and thus operating speed of accessing the storage device may be increased.

The example embodiments are applicable to a non-volatile memory device and various apparatuses and systems using the same. Therefore, the example embodiments may be used in any device or system including a nonvolatile memory device, such as a mobile phone, a smart phone, a PDA, a PMP, a digital camera, a digital television, a set-top box, a music player, a portable game console, a navigation device, a PC, a server computer, a workstation, a tablet computer, a laptop computer, a smart card, a printer, etc.

The foregoing is illustrative of embodiments and is not to be construed as limiting thereof. Although a few embodiments have been described, those skilled in the art will readily appreciate that many modifications are possible in the embodiments without materially departing from the scope of the inventive concept as set forth in the accompanying claims.

What is claimed is:

1. A storage device comprising:
a nonvolatile storage including a map table which stores information including a logical address, a physical address corresponding to the logical address and a correlation index designating the physical address; and
a storage controller configured to transmit the information to an external host device, and to access the nonvolatile storage based on a request and the correlation index transmitted from the host device.

2. The storage device of claim 1, wherein the storage controller is configured to directly access a physical page of the nonvolatile storage in response to the physical address indicating as the correlation index transmitted from the host device.

3. The storage device of claim 1, wherein when the request is a write request, the correlation index transmitted from the host device corresponds to a correlation index designating a free page of the nonvolatile storage.

4. The storage device of claim 1, wherein when the request is a read request, the correlation index transmitted from the host device corresponds to a correlation index designating a data page of the nonvolatile storage.

5. The storage device of claim 1, wherein the storage controller comprises:
a register unit including a command queue configured to store a command corresponding to the request, and an update table configured to store the correlation index,
wherein the update table further stores a valid tag that represent whether a physical address corresponding to the correlation index is updated and whether the physical address is valid.

6. A storage system comprising:
a storage device including a nonvolatile storage that includes a map table which stores information including a logical address, a physical address corresponding to the logical address and a correlation index designating the physical address; and
a host device including a main memory configured to store the information of the map table of the nonvolatile storage, the host device configured to transmit the logical address and the correlation index with a request to the storage device,
wherein the host device is configured to access the nonvolatile storage based on the request, the logical address and the correlation index.

7. The storage system of claim 6, wherein the storage device further includes a storage controller configured to directly access a physical page of the nonvolatile storage in response to the physical address indicating as the correlation index transmitted from the host device.

8. The storage system of claim 7, wherein the storage controller comprises:
a processor configured to control overall operation of the storage device;
a register unit configured to store a command corresponding to the request, the logical address and the correlation index;
a host interface electrically coupled to the host device; and
a memory interface electrically coupled to the nonvolatile storage.

9. The storage system of claim 8, wherein the processor is configured to transmit a message to the host device after the processor loads the information to the register unit, and the host device is configured to store the information in the main memory in response to the message.

10. The storage system of claim 8, wherein the register unit comprises:
a command queue configured to store a command corresponding to the request; and
an update table configured to store the correlation index,
wherein the update table is further configured to store a valid tag that represent whether a physical address corresponding to the correlation index is updated and whether the physical address is valid, and
wherein the storage controller is configured to refer to the update table, and directly access data associated with the physical address corresponding to the correlation index transmitted from the host device.

11. The storage system of claim 6, wherein when the request is a write request, the correlation index transmitted from the host device corresponds to a correlation index designating a free page of the nonvolatile storage.

12. The storage system of claim 6, wherein when the request is a read request, the correlation index transmitted from the host device corresponds to a correlation index designating a data page of the nonvolatile storage.

13. The storage system of claim 6, wherein the host device further comprises a central processing unit configured to control overall operation of the host device and the central processing unit is coupled to the main memory and the storage device each coupled through individual interface.

14. The storage system of claim 6, wherein the host device further comprises a central processing unit configured to control overall operation of the host device and the central processing unit is coupled to the main memory and the storage device each coupled through a common interface.

15. The storage system of claim 6, wherein the main memory includes a dynamic random access memory (DRAM) and the nonvolatile storage includes a NAND flash memory.

16. A method of operating a storage system, the method comprising:
storing information to a map table of a nonvolatile storage, the information including a logical address, a physical address corresponding to the logical address, and a correlation index specifying the physical address;
transmitting the information to a host and storing the transmitted information in a main memory of the host;
transmitting a request and the information from the host to a storage controller; and
accessing the nonvolatile storage based on the request and the correlation index transmitted from the host.

17. The method of claim 16, further comprising:
transmitting a message from the storage controller to the host such that the main memory of the host receives the information from the storage controller.

18. The method of claim 16, wherein if the request is a write request, the correlation index transmitted from the host corresponds to a free page of the nonvolatile storage.

19. The method of claim 16, wherein if the request is a read request, the correlation index transmitted from the host corresponds to a data page of the nonvolatile storage.

20. The method of claim 16, wherein the nonvolatile storage includes a NAND flash memory and the main memory includes a dynamic random access memory (DRAM).
